(19) United States
(12) Patent Application Publication
(10) Pub. No.: US 2023/0171612 A1
(43) Pub. Date: Jun. 1, 2023

(54) NETWORK DEVICE AND METHOD FOR BEAM ALIGNMENT

(71) Applicant: Mediatek Inc., Hsin-Chu (TW)

(72) Inventor: CHIEN-HWA Hwang, Hsin-Chu (TW)

(21) Appl. No.: 17/982,486

(22) Filed: Nov. 7, 2022

Related U.S. Application Data
(60) Provisional application No. 63/284,690, filed on Dec. 1, 2021.

(51) Int. Cl. H04W 16/28; H04B 7/06

(52) U.S. Cl. CPC H04W 16/28; H04B 7/061

(57) ABSTRACT

Network device and method are provided for beam alignment. In particular, a network device can connect to another work device in a network. The network device can obtain a first location of the network device and a second location of the another network device, and derive a beam path information corresponding to the first location and the second location from a database. The network device can determine a beam angle for communicating with the another network device according to the at least one beam path information. The another network device can receive the at least one beam path information, and determine a beam angle for communicating with the network device according to the at least one beam path information.

### CROSS REFERENCE TO RELATED APPLICATIONS

This application claims priority under 35 U.S.C. § 119 from U.S. Provisional Application No. 63/284,690, entitled “Positioning, Sensing and Machine Learning Assisted Beam Alignment,” filed on Dec. 1, 2021, the subject matter of which is incorporated herein by reference.

### TECHNICAL FIELD

The disclosed embodiments relate generally to wireless communication, and, more particularly, to network device and method for positioning, sensing and machine learning assisted beam alignment.

### BACKGROUND

In conventional network of 3rd generation partnership project (3GPP) 5G new radio (NR), to a pair of a transmitter (Tx) and a receiver (Rx) communicating at a very high radio frequency, the measured paths therebetween are sparse since the angle of departure (AoD) of antenna of Tx and the angle of arrival (AoA) of antenna of Rx consist of few angles. Therefore, beam sweeping over the whole field of view, which is very time consuming, may not be needed. Further, for a pair of the Tx and the Rx located at known positions, when the measurement results are available, beam alignment may be performed efficiently by trying only some specific pairs of AoA and AoD.

However, how to determine a pair of AoA and AoD to establish a beam pair link correctly and efficiently between the Tx and the Rx has not been discussed yet.

### SUMMARY

Network device and method are provided for beam alignment. In particular, a network device can connect to another work device in a network. The network device can obtain a first location of the network device and a second location of the another network device, and derive at least one beam path information corresponding to the first location and the second location from a database. The network device can determine a beam angle for communicating with the another network device according to the at least one beam path information. The another network device can receive the at least one beam path information, and determine a beam angle for communicating with the network device according to the at least one beam path information.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio network supporting beam alignment in accordance with embodiments of the current invention.

FIG. 2 is a simplified block diagram of the network devices in accordance with embodiments of the current invention.

FIG. 3 illustrates messages transmissions in accordance with embodiments of the current invention.

FIG. 4 illustrates messages transmissions in accordance with embodiments of the current invention.

FIG. 5 is a flow chart of a method of beam alignment in accordance with embodiments of the current invention.

FIG. 6 is a flow chart of a method of beam alignment in accordance with embodiments of the current invention.

FIGS. 7A to 7C are flow charts of a method of beam alignment in accordance with embodiments of the current invention.

FIGS. 8A to 8E are flow charts of a method of beam alignment in accordance with embodiments of the current invention.

### DETAILED DESCRIPTION

Reference will now be made in detail to some embodiments of the invention, examples of which are illustrated in the accompanying drawings.

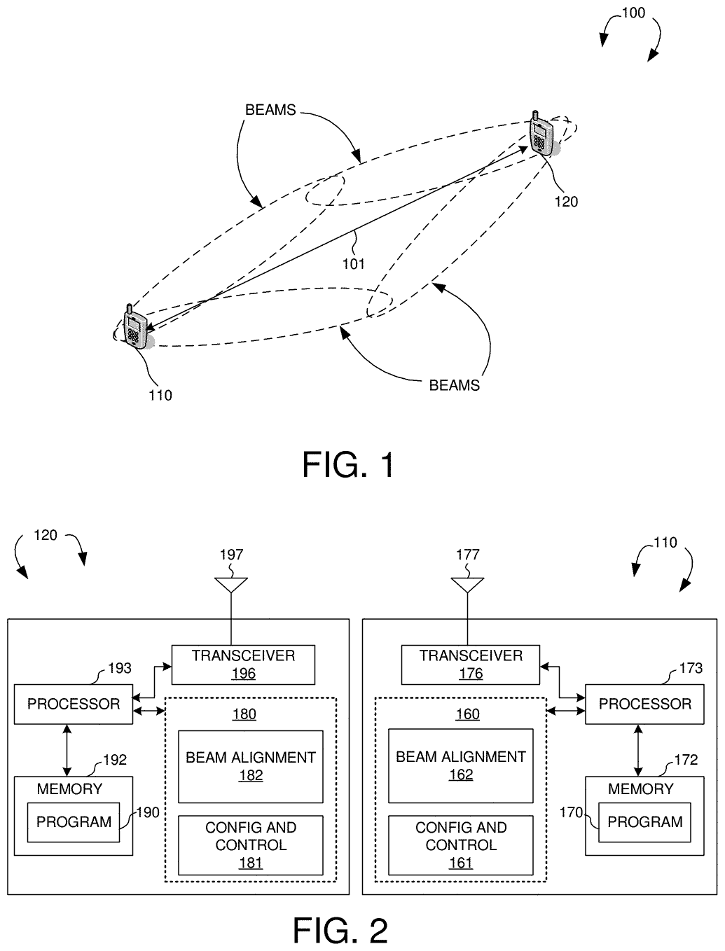

FIG. 1 illustrates an exemplary 5G new radio (NR) network 100 supporting beam alignment in accordance with aspects of the current invention. The 5G NR network 100 includes a network device 110 communicatively connected to a network device 120. In some embodiments, the network devices 110 and 120 may be a base station (BS) (e.g., a gNB) or a user equipment (UE).

For example, when the network device 110/120 is a gNB, the network device 110/120 can be operated in a licensed band (e.g., 30 GHz-300 GHz for mmWave) of an access network which provides radio access using a Radio Access Technology (RAT) (e.g., the 5G NR technology). The access network is connected to a 5G core network (not shown) by means of the NG interface, more specifically to a User Plane Function (UPF) by means of the NG user-plane part (NG-u), and to a Mobility Management Function (AMF) by means of the NG control-plane part (NG-c). One network device 110/120 can be connected to multiple UPFs/AMFs for the purpose of load sharing and redundancy.

For example, when the network device 110/120 is a UE, the network device 110/120 may be a smart phone, a wearable device, an Internet of Things (IoT) device, and a tablet, etc. Alternatively, the network device 110/120 may be a Notebook (NB) or Personal Computer (PC) inserted or installed with a data card which includes a modem and RF transceiver(s) to provide the functionality of wireless communication.

FIG. 2 is a simplified block diagram of the network device 110 and 120 in accordance with embodiments of the present invention. For the network device 110, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the network device 110. Memory 192 stores program instructions and data 190 to control the operations of the network device 110.

Similarly, for the network device 120, antenna 177 transmits and receives RF signals. RF transceiver module 176, coupled with the antenna, receives RF signals from the antenna, converts them to baseband signals and sends them to processor 173. The RF transceiver 176 also converts received baseband signals from the processor 173, converts them to RF signals, and sends out to antenna 177. Processor 173 processes the received baseband signals and invokes different functional modules and circuits to perform features in the network device 120. Memory 172 stores program instructions and data 170 to control the operations of the network device 120.

The network devices 110 and 120 also include several functional modules and circuits that can be implemented and configured to perform embodiments of the present invention. In the example of FIG. 2, the network device 110 includes a set of control functional modules and circuit 180. Beam alignment circuit 182 handles beam alignment and associated network parameters. Configuration and control circuit 181 provides different parameters to configure and control the network device 120 or handles different configuration and control parameters from the network device 120. The network device 120 includes a set of control functional modules and circuit 160. Beam alignment circuit 162 handles beam alignment and associated network parameters. Configuration and control circuit 161 provides different parameters to configure and control the network device 110 or handles different configuration and control parameters from the network device 110.

Note that the different functional modules and circuits can be implemented and configured by software, firmware, hardware, and any combination thereof. The function modules and circuits, when executed by the processors 193 and 173 (e.g., via executing program codes 190 and 170), allow the network devices 110 and 120 to perform embodiments of the present invention.

In some embodiments, the network devices 110 and 120 may communicate with each other via different angles (e.g., angle of departure (AoD) of transmitting device and angle of arrival (AoA) of receiving device) of beams (as shown in FIG. 1). The network devices 110 and 120 may communicate with each other via at least one communication link 101 in different frequency ranges (e.g., high frequency range and low frequency range). According to some pre-stored beam path information, the network devices 110 and 120 may determine their angles of beams for establishing a beam pair link correctly and efficient.

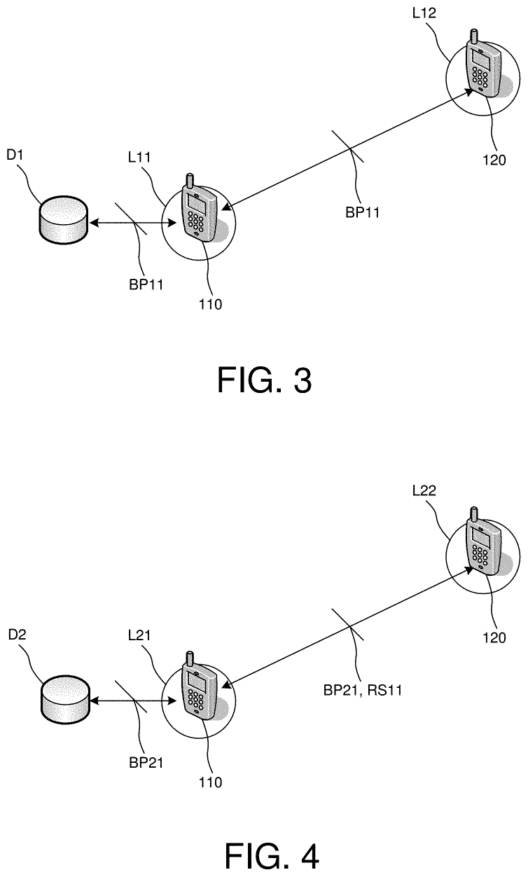

FIG. 3 illustrates one embodiment of message transmissions in accordance with embodiments of the current invention. In some embodiments, the network device 110 is a transmitter (Tx), and the network device 120 is a receiver (Rx). In particular, the network device 110 obtains a first location L11 of the network device 110 and a second location L12 of the network device 120. Then, the network device 110 derives at least one beam path information BP11 corresponding to the first location L11 and the second location L12 from a database D1. In some embodiments, the network device 110 transmits the at least one beam path information BP11 to the network device 120.

From perspective of the network device 110, the network device 110 determines a first beam angle (i.e., AoD) for communicating with the network device 120 according to the at least one beam path information BP11. From perspective of the network device 120, the network device 110 determines a second beam angle (i.e., AoA) for communicating with the network device 110 according to the at least one beam path information BP11. Therefore, the network devices 110 and 120 establish a beam pair link therebetween according to the first beam angle of the network device 110 and the second beam angle of the network device 120.

FIG. 4 illustrates one embodiment of message transmissions in accordance with embodiments of the current invention. In some embodiments, the network device 110 is a Tx, and the network device 120 is an Rx. In particular, the network device 110 determines a first location L21 of the network device 110 (e.g., by a GPS module of the network device 110). The network device 120 determines a second location L22 of the network device 120 (e.g., by a GPS module of the network device 120).

In some embodiments, the network device 110 may communicate with the network device 120 via the communication link 101 in low frequency range. Accordingly, the network device 120 transmits the second location L22 of the network device 120 to the network device 110. The network device 110 receives the second location L22 of the network device 120 from the network device 120.

Then, the network device 110 derives at least one beam path information BP21 corresponding to the first location L21 and the second location L22 from a database D2. Specifically, the database D2 stores a table (as shown in table 1 below) of a plurality of beam path information, and each beam path information has at least the fields of: (1) pair of locations; (2) AoD; (3) AoA; and (4) weight.

TABLE 1

| Pair of location | AoD | AoA | Weight |
|---|---|---|---|
| (X₁₁, X₁₂) | A₁₁ | A₁₂ | W₁ |
| (X₂₁, X₂₂) | A₂₁ | A₂₂ | W₂ |
| (X₃₁, X₃₂) | A₃₁ | A₃₂ | W₃ |
| (X₄₁, X₄₂) | A₄₁ | A₄₂ | W₄ |
| (X₅₁, X₅₂) | A₅₁ | A₅₂ | W₅ |
| (X₆₁, X₆₂) | A₆₁ | A₆₂ | W₆ |
| . . . | . . . | . . . | . . . |

In some embodiments, the data base D2 may be installed in the network device 110. In these embodiments, the network device 110 compares the pair of the first location L21 and the second location L22 with the field of pair of locations of each beam path information in the table 1. The network device 110 determines at least one beam path information BP21 whose field of pair of locations matches the pair of the first location L21 and the second location L22.

For example, when the network device 110 determines that the pair of the first location L21 and the second location L22 matches the pair (X₁₁, X₁₂) of locations in the table 1, the network device 110 determines the beam path information BP21 including AoD A₁₁, AoA A₁₂ and weight W₁. For another example, when the network device 110 determines that the pair of the first location L21 and the second location L22 matches: (1) the pair (X₁₁, X₁₂) of locations; and (2) the pair (X₆₁, X₆₂) of locations in the table 1, the network device 110 determines: (1) the beam path information BP21 including AoD A₁₁, AoA A₁₂ and weight W₁; and the beam path information BP21 including AoD A₆₁, AoA A₆₂ and weight W₆.

In some embodiments, the database D2 may be installed in a server (not shown). In these embodiments, the network device 110 transmits the pair of the first location L21 and the second location L22 to the server so that the server compares the pair of the first location L21 and the second location L22 with the field of pair of locations of each beam path information in the table 1. The server determines the at least one beam path information BP21 whose field of pair of locations matches the pair of the first location L21 and the second location L22, and then transmits the at least one beam path information BP21 to the network device 110.

For example, when the server determines that the pair of the first location L21 and the second location L22 matches the pair (X₁₁, X₁₂) of locations in the table 1, the server determines the beam path information BP21 including AoD A₁₁, AoA A₁₂ and weight W₁, and then transmits the beam path information BP21 to the network device 110. For another example, when the server determines that the pair of the first location L21 and the second location L22 matches: (1) the pair (X₁₁, X₁₂) of locations; and (2) the pair (X₆₁, X₆₂) of locations in the table 1, the server determines: (1) the beam path information BP21 including AoD A₁₁, AoA A₁₂ and weight W₁; and the beam path information BP21 including AoD A₆₁, AoA A₆₂ and weight W₆, and then transmits the beam path information BP21 to the network device 110.

After deriving the beam path information BP21, the network device 110 selects the beam path information BP21 having the highest weight and transmits at least the AoA of the selected beam path information BP21 to the network device 120.

Then, from perspective of the network device 110, the network device 110 adjusts an antenna array of the network device 110 by: (1) the AoD of the selected beam path information BP21; and (2) an orientation of the network device 110. In some embodiments, the adjustment of the antenna array of the network device 110 may be the adjustment of phase shifter(s) of the antenna array. The orientation of the network device 110 may be sensed by an orientation sensor (not shown) of the network device 110.

From perspective of the network device 120, the network device 120 adjusts an antenna array of the network device 120 by: (1) the AoA of the selected beam path information BP21; and (2) an orientation of the network device 120. In some embodiments, the adjustment of the antenna array of the network device 120 may be the adjustment of phase shifter(s) of the antenna array. The orientation of the network device 120 may be sensed by an orientation sensor (not shown) of the network device 120. It should be noted that the orientation sensors of the network devices 110 and 120 may be pre-aligned to sense the same orientations.

Next, in some embodiments, the network device 110 may communicate with the network device 120 via the communication link 101 in very high frequency (e.g., mmWave) range. Accordingly, for determining the beam quality of transmission between the network devices 110 and 120 in the very high frequency (e.g., mmWave) range, the network device 110 transmits a reference signal RS11 to the network device 120 in the very high frequency range after adjusting the antenna array. The network device 120 receives the reference signal RS11 from the network device 110 in the very high frequency range after adjusting the antenna array. Then, the network device 120 determines whether a measurement of the reference signal R11 is greater than a threshold.

If the measurement of the reference signal R11 is greater than the threshold, the network device 120 determines the AoA of the selected beam path information BP21 as a beam angle for establishing a beam pair link. The network device 120 transmits a positive acknowledgement to the network device 110. After receiving the positive acknowledgement, the network device 110 determines the AoD of the selected beam path information BP21 as a beam angle for establishing the beam pair link.

If the measurement of the reference signal R11 is not greater than the threshold, the network device 120 transmits a negative acknowledgement to the network device 110. After receiving the negative acknowledgement, the network device 110 reselects the beam path information BP21 having the second highest weight and transmits at least the AoA of the reselected beam path information BP21 to the network device 120.

Then, from perspective of the network device 110, the network device 110 readjusts the antenna array of the network device 110 by: (1) the AoD of the reselected beam path information BP21; and (2) the orientation of the network device 110.

From perspective of the network device 120, the network device 120 readjusts an antenna array of the network device 120 by: (1) the AoA of the reselected beam path information BP21; and (2) the orientation of the network device 120.

Next, the network device 110 transmits the reference signal RS11 to the network device 120 after readjusting the antenna array. The network device 120 receives the reference signal RS11 from the network device 110 after readjusting the antenna array. The network device 120 determines whether a measurement of the reference signal R11 is greater than the threshold.

If the measurement of the reference signal R11 is greater than the threshold, the network device 120 determines the AoA of the reselected beam path information BP21 as the beam angle for establishing the beam pair link. The network device 120 transmits a positive acknowledgement to the network device 110. After receiving the positive acknowledgement, the network device 110 determines the AoD of the reselected beam path information BP21 as the beam angle for establishing the beam pair link.

If the measurement of the reference signal R11 is not greater than the threshold, the network device 120 transmits a negative acknowledgement to the network device 110. After receiving the negative acknowledgement, the network device 110 reselects the beam path information BP21 having the next highest weight and transmits at least the AoA of the reselected beam path information BP21 to the network device 120. The operations followed the reselection of the beam path information BP21 are the same as the above description and will be not further described hereinafter.

In some embodiments, when the network devices 110 and 120 successfully determines the beam angles for establishing the beam pair link, the network device 110 updates the weight of the selected beam path information BP21.

For example, when the database D2 is installed in the network device 110, the network device 110 updates the weight of the selected beam path information BP21 in the table 1 by: (1) raising the weight directly; or (2) updating the weight by machine learning mechanism.

For another example, when the database D2 is installed in the server, the network device 110 transmits the selected beam path information BP21 of successful beam pair link to the server and the server updates the weight of the selected beam path information BP21 in the table 1 by: (1) raising the weight directly; or (2) updating the weight by machine learning mechanism.

In some embodiments, the network devices 110 and 120 may be applied by the same coordination system (e.g., an x-y-z three-axes coordination system) so that the network devices 110 and 120 may have the same benchmark of beam angle. The network devices 110 and 120 may be able to communication with each other to agree on a common coordination system or may apply the same coordination system by a default configuration.

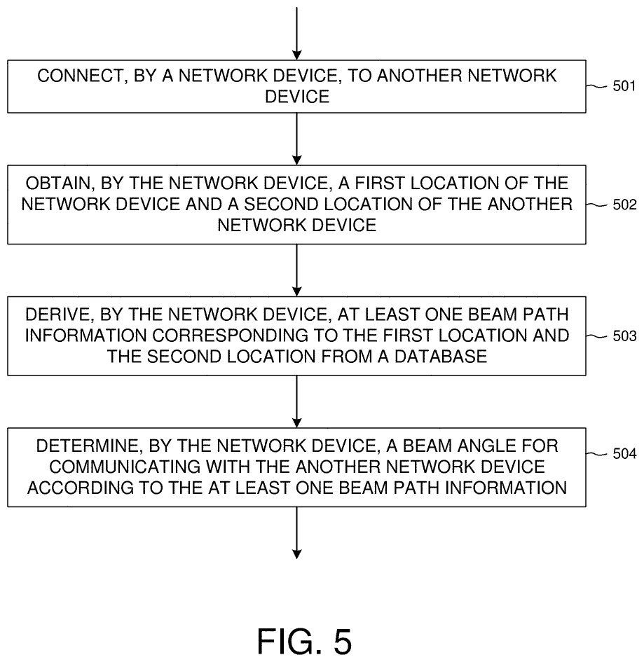

FIG. 5 is a flow chart of a method for beam alignment in a 5G/NR network in accordance with one novel aspect. In step 501, a network device connects to another network device. In step 502, the network device obtains a first location of the network device and a second location of the another network device.

In step 503, the network device derives at least one beam path information corresponding to the first location and the second location from a database. In step 504, the network device determines a beam angle for communicating with the another network device according to the at least one beam path information.

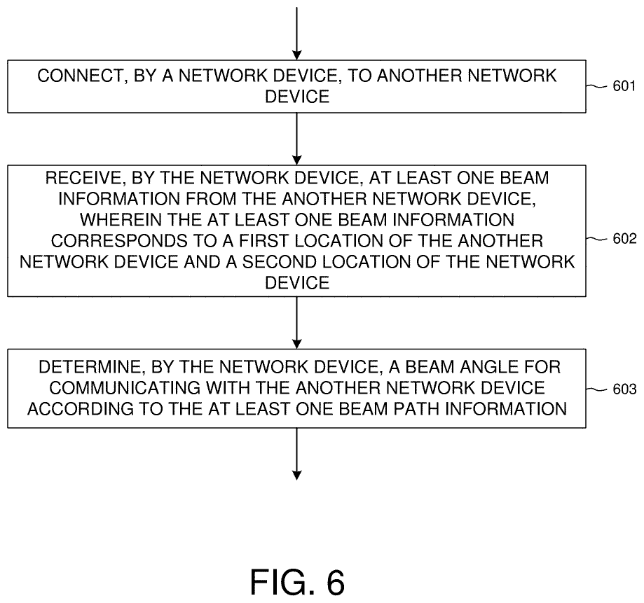

FIG. 6 is a flow chart of a method for beam alignment in a 5G/NR network in accordance with one novel aspect. In step 601, a network device connects to another network device. In step 602, the network device receives at least one beam information from the another network device. The at least one beam information corresponds to a first location of the another network device and a second location of the network device. In step 603, the network device determines a beam angle for communicating with the another network device according to the at least one beam path information.

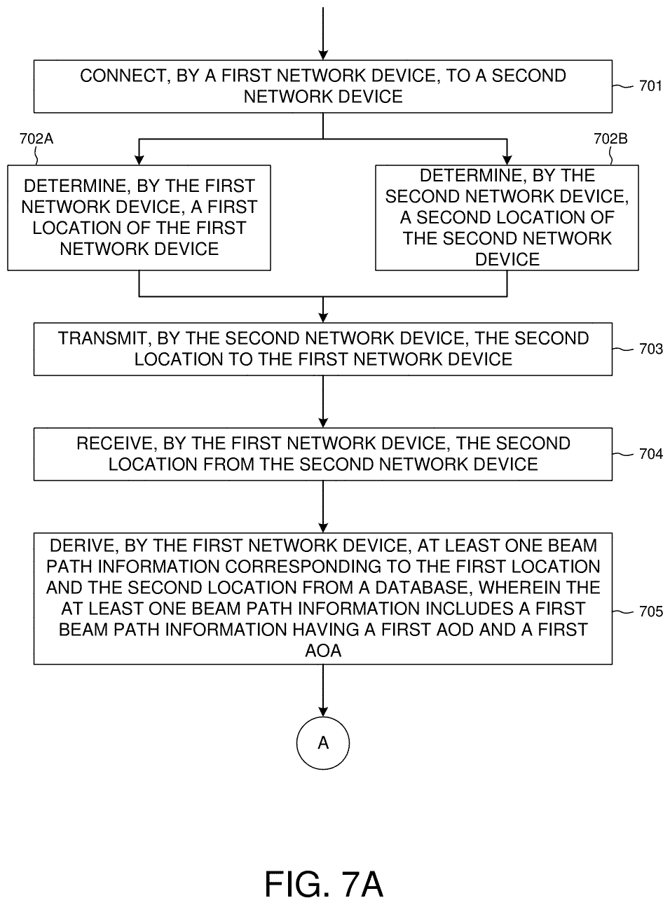

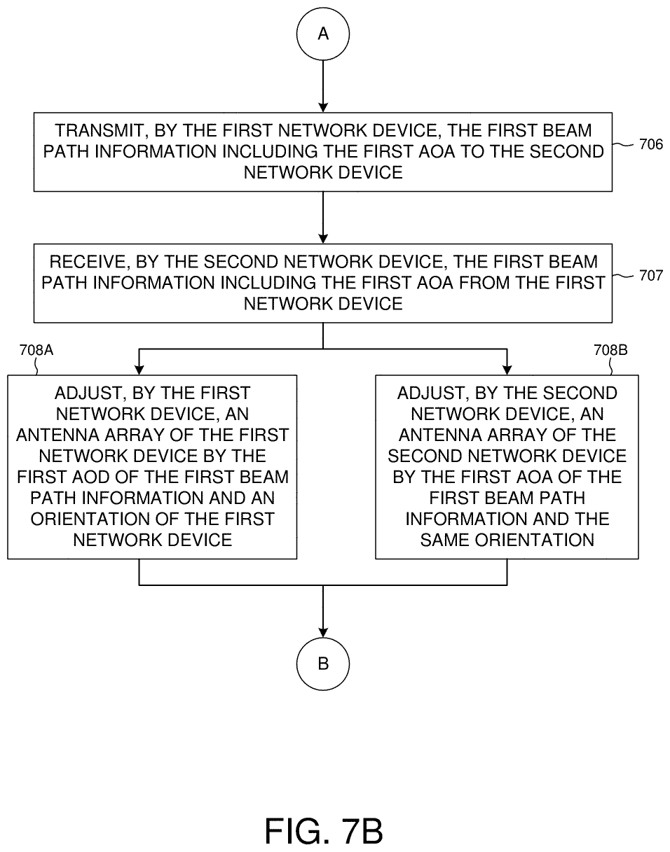

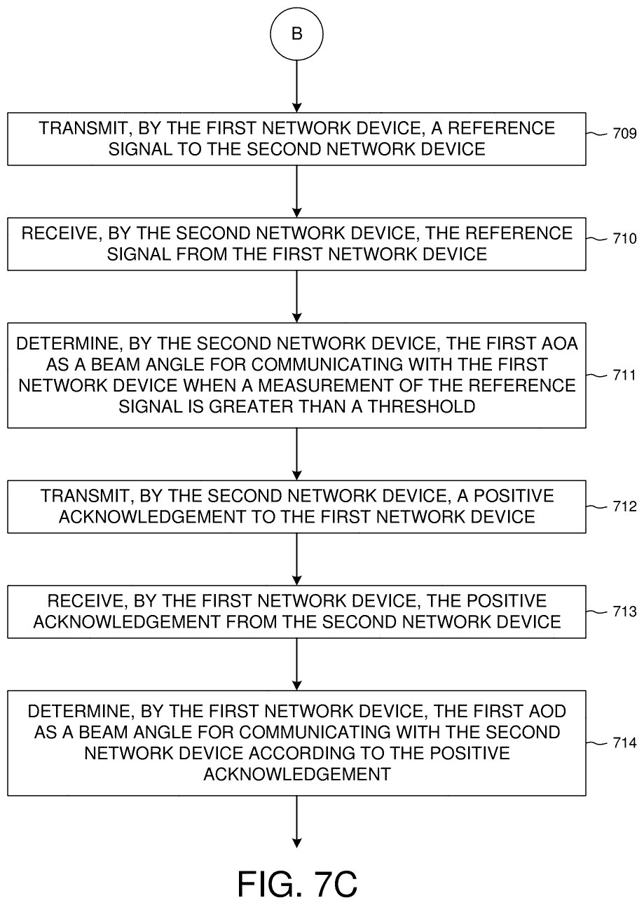

FIGS. 7A to 7C are flow charts of a method for beam alignment in a 5G/NR network in accordance with one novel aspect. In step 701, a first network device connects to a second network device. In step 702A, the first network device determines a first location of the first network device. In step 702B, the second network device determines a second location of the second network device.

In step 703, the second network device transmits the second location to the first network device. In step 704, the first network device receives the second location. In step 705, the first network device derives at least one beam path information corresponding to the first location and the second location from a database. The at least one beam path information includes a first beam path information having a first AoD and a first AoA.

In step 706, the first network device transmits the first beam path information including the first AoA to the second network device. In step 707, the second network device receives the first beam path information including the first AoA from the first network device.

In step 708A, the first network device adjusts an antenna array of the first network device by the first AoD of the first beam path information and an orientation of the first network device. In step 708B, the second network device adjusts an antenna array of the second network device by the first AoA of the first beam path information and the same orientation.

In step 709, the first network device transmits a reference signal to the second network device. In step 710, the second network device receives the reference signal from the first network device. In step 711, the second network device determines the first AoA as a beam angle for communicating with the first network device when a measurement of the reference signal is greater than a threshold.

In step 712, the second network device transmits a positive acknowledgement to the first network device. In step 713, the first network device receives the positive acknowledgement from the second network device. In step 714, the first network device determines the first AoD as a beam angle for communicating with the second network device according to the positive acknowledgement.

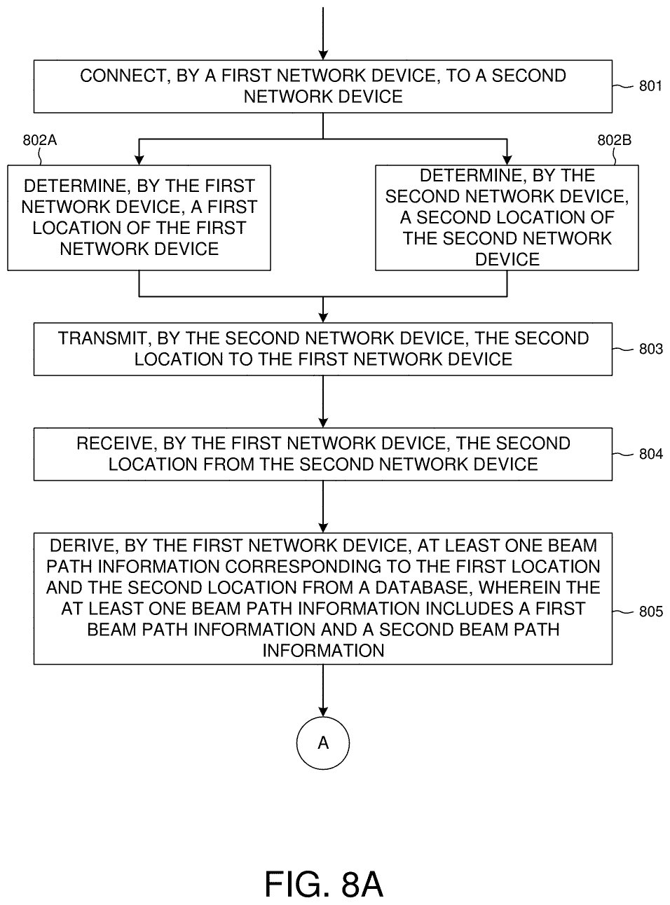

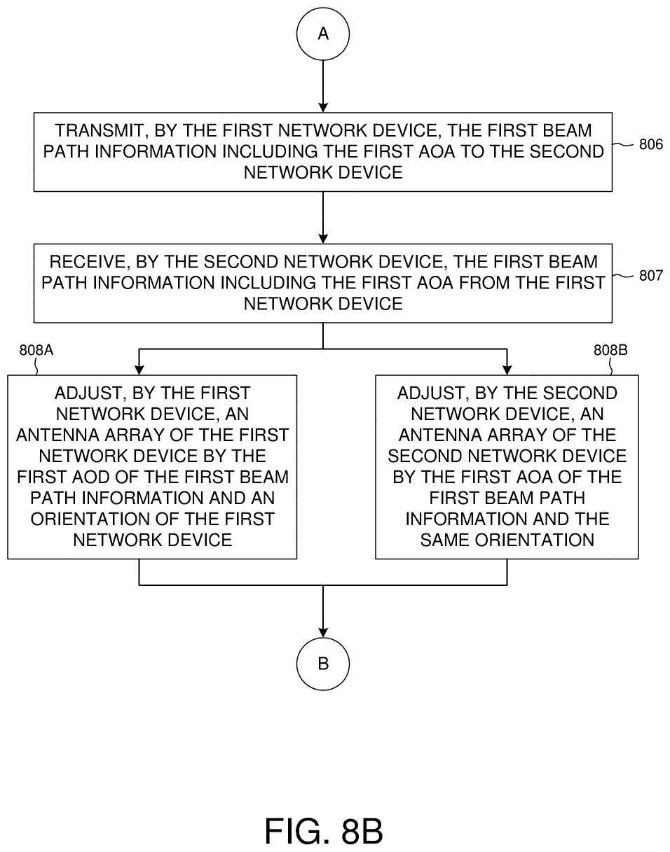

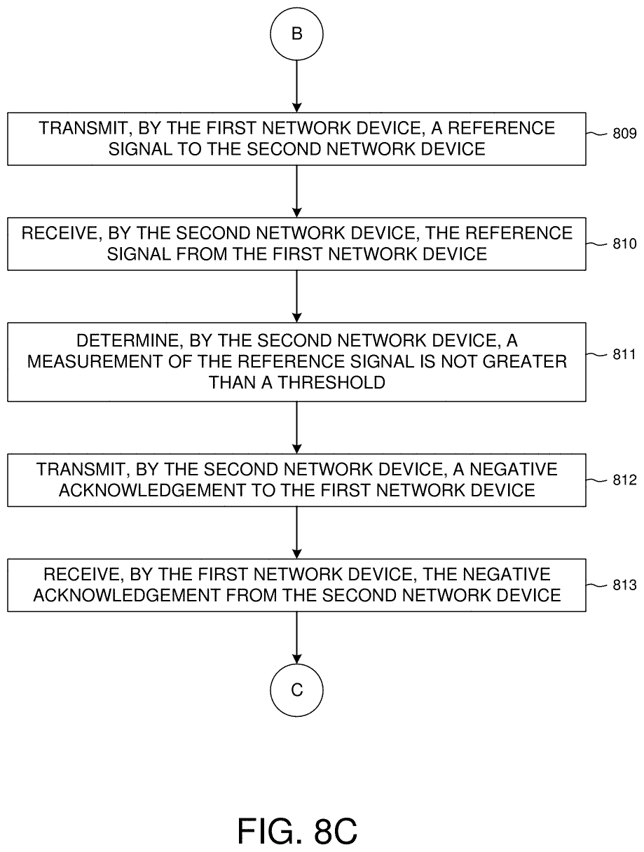

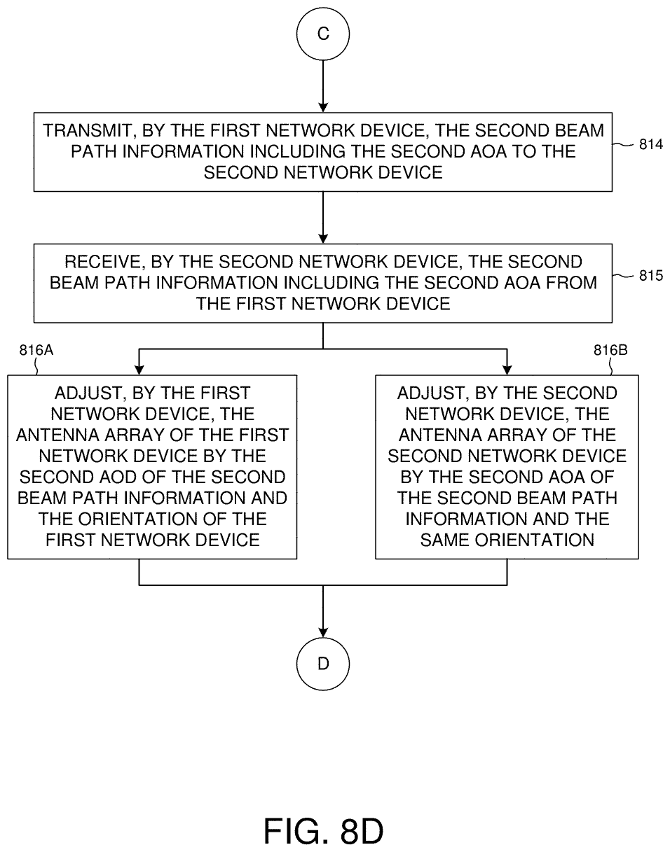

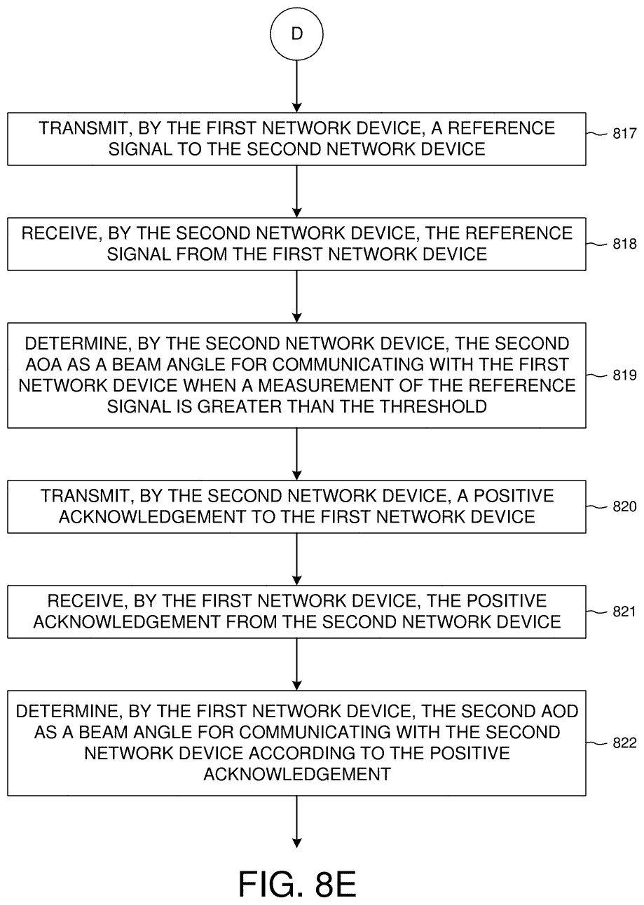

FIGS. 8A to 8D are flow charts of a method for beam alignment in a 5G/NR network in accordance with one novel aspect. In step 801, a first network device connects to a second network device. In step 802A, the first network device determines a first location of the first network device. In step 802B, the second network device determines a second location of the second network device.

In step 803, the second network device transmits the second location to the first network device. In step 804, the first network device receives the second location. In step 805, the first network device derives at least one beam path information corresponding to the first location and the second location from a database. The at least one beam path information includes: (1) a first beam path information having a first AoD, a first AoA and a first weight; and (2) a second beam path information having a second AoD, a second AoA and a second weight. The first weight is greater than the second weight.

In step 806, the first network device transmits the first beam path information including the first AoA to the second network device. In step 807, the second network device receives the first beam path information including the first AoA from the first network device.

In step 808A, the first network device adjusts an antenna array of the first network device by the first AoD of the first beam path information and an orientation of the first network device. In step 808B, the second network device adjusts an antenna array of the second network device by the first AoA of the first beam path information and the same orientation.

In step 809, the first network device transmits a reference signal to the second network device. In step 810, the second network device receives the reference signal from the first network device. In step 811, the second network device determines a measurement of the reference signal is not greater than a threshold.

In step 812, the second network device transmits a negative acknowledgement to the first network device. In step 813, the first network device receives the negative acknowledgement from the second network device.

In step 814, the first network device transmits the second beam path information including the second AoA to the second network device. In step 815, the second network device receives the second beam path information including the second AoA from the first network device.

In step 816A, the first network device adjusts the antenna array of the first network device by the second AoD of the second beam path information and the orientation of the first network device. In step 816B, the second network device adjusts the antenna array of the second network device by the second AoA of the second beam path information and the same orientation.

In step 817, the first network device transmits a reference signal to the second network device. In step 818, the second network device receives the reference signal from the first network device. In step 819, the second network device determines the second AoA as a beam angle for communicating with the first network device when a measurement of the reference signal is greater than the threshold.

In step 820, the second network device transmits a positive acknowledgement to the first network device. In step 821, the first network device receives the positive acknowledgement from the second network device. In step 822, the first network device determines the second AoD as a beam angle for communicating with the second network device according to the positive acknowledgement.

In some embodiments, the first network device updates the first weight of the first beam path information after failing to use the first AoD as the beam angle. In some embodiments, the first network device updates the second weight of the second beam path information after determining the second AoD as the beam angle. In some embodiments, the first network device and the second network device are applied by the same coordination system.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A network device, comprising:
a transceiver that:
connects to another network device;
a beam alignment circuit that:
obtains a first location of the network device and a second location of the another network device;
derives at least one beam path information corresponding to the first location and the second location from a database; and
determines a beam angle for communicating with the another network device according to the at least one beam path information.

2. The network device of claim 1, wherein obtaining the first location and the second location further comprises:
determining the first location of the network device; and
receiving the second location of the another network device from the another network device.

3. The network device of claim 1, wherein the at least one beam path information includes a first beam path information having a first angle of departure (AoD) and a first angle of arrival (AoA), and determining the beam angle for communicating with the another network device according to the at least one beam path information further comprises:
adjusting an antenna array of the network device by the first AoD of the first beam path information and an orientation of the network device;
transmitting a reference signal to the another network device after adjusting the antenna array;
receiving a positive acknowledgement from the another network device when the another network device determines a measurement of the reference signal is greater than a threshold;
determining the first AoD as the beam angle according to the positive acknowledgement.

4. The network device of claim 3, wherein the beam alignment circuit further:
transmits the first AoA of the first beam path information to the another network device so that the another work device adjusts an antenna array of the another network device by the first AoA of the first beam path information and the same orientation.

5. The network device of claim 3, wherein the first beam path information further has a weight, and the beam alignment circuit further:
updates the weight after determining the first AoD as the beam angle.

6. The network device of claim 1, wherein the at least one beam path information includes a first beam path information and a second beam path information, the first beam path information has a first angle of departure (AoD), a first angle of arrival (AoA) and a first weight, the second beam path information has a second AoD, a second AoA and a second weight, the first weight is greater than the second weight, and determining the beam angle for communicating with the another network device according to the at least one beam path information further comprises:
adjusting an antenna array of the network device by the first AoD of the first beam path information and an orientation of the network device;
transmitting a first reference signal to the another network device after adjusting the antenna array;
receiving a negative acknowledgement from the another network device when the another network device determines a measurement of the first reference signal is not greater than a threshold;
adjusting the antenna array of the network device by the second AoD of the second beam path information and the orientation of the network device;
transmitting a second reference signal to the another network device after adjusting the antenna array;
receiving a positive acknowledgement from the another network device when the another network device determines a measurement of the second reference signal is greater than the threshold;
determining the second AoD as the beam angle according to the positive acknowledgement.

7. The network device of claim 6, wherein the beam alignment circuit further:
transmits the first AoA of the first beam path information and the second AoA of the second beam path information to the another network device so that the another work device adjusts an antenna array of the another network device by the first AoA of the first beam path information and the same orientation and by the second AoA of the second beam path information and the same orientation.

8. The network device of claim 1, wherein the network device and the another network device are applied by a coordination system.

9. A network device, comprising:
a transceiver that:
connects to another network device;
a beam alignment circuit that:
receives at least one beam information from the another network device, wherein the at least one beam information corresponds to a first location of the another network device and a second location of the network device;
determines a beam angle for communicating with the another network device according to the at least one beam path information.

10. The network device of claim 9, wherein the at least one beam path information includes a first beam path information having a first angle of arrival (AoA), and determining the beam angle for communicating with the another network device according to the at least one beam path information further comprises:
adjusting an antenna array of the network device by the first AoA of the first beam path information and an orientation of the network device;
receiving a reference signal from the another network device after adjusting the antenna array;
determining the first AoA as the beam angle when a measurement of the reference signal is greater than a threshold;
transmitting a positive acknowledgement to the another network device.

11. The network device of claim 9, wherein the at least one beam path information includes a first beam path information and a second beam path information, the first beam path information has a first angle of arrival (AoA) and a first weight, the second beam path information has a second AoA and a second weight, the first weight is greater than the second weight, and determining the beam angle for communicating with the another network device according to the at least one beam path information further comprises:
adjusting an antenna array of the network device by the first AoA of the first beam path information and an orientation of the network device;
receiving a first reference signal from the another network device after adjusting the antenna array;
determining that a measurement of the first reference signal is not greater than a threshold;
transmitting a negative acknowledgement associated to the another network device;
adjusting the antenna array of the network device by the second AoA of the second beam path information and the orientation of the network device;
receiving a second reference signal from the another network device after adjusting the antenna array;
determining the second AoA as the beam angle when a measurement of the second reference signal is greater than the threshold;
transmitting a positive acknowledgement to the another network device.

12. A method, comprising:
obtaining, by a network device, a first location of the network device and a second location of another network device;
deriving, by the network device, at least one beam path information corresponding to the first location and the second location from a database;
determining, by the network device, a beam angle for communicating with the another network device according to the at least one beam path information.

13. The method of claim 12, wherein the step of obtaining the first location and the second location further comprises:
determining, by the network device, the first location of the network device; and
receiving, by the network device, the second location of the another network device from the another network device.

14. The method of claim 12, wherein the at least one beam path information includes a first beam path information having a first angle of departure (AoD) and a first angle of arrival (AoA), and the step of determining the beam angle for communicating with the another network device according to the at least one beam path information further comprises:
adjusting, by the network device, an antenna array of the network device by the first AoD of the first beam path information and an orientation of the network device;
transmitting, by the network device, a reference signal to the another network device after adjusting the antenna array;
receiving, by the network device, a positive acknowledgement from the another network device when the another network device determines a measurement of the reference signal is greater than a threshold;
determining, by the network device, the first AoD as the beam angle according to the positive acknowledgement.

15. The method of claim 14, further comprising:
transmitting, by the network device, the first AoA of the first beam path information to the another network device so that the another work device adjusts an antenna array of the another network device by the first AoA of the first beam path information and the same orientation.

16. The method of claim 14, wherein the first beam path information further has a weight, and the method further comprises:
updating, by the network device, the weight after determining the first AoD as the beam angle.

17. The method of claim 12, wherein the at least one beam path information includes a first beam path information and a second beam path information, the first beam path information has a first angle of departure (AoD), a first angle of arrival (AoA) and a first weight, the second beam path information has a second AoD, a second AoA and a second weight, the first weight is greater than the second weight, and the step of determining the beam angle for communicating with the another network device according to the at least one beam path information further comprises:
adjusting, by the network device, an antenna array of the network device by the first AoD of the first beam path information and an orientation of the network device;
transmitting, by the network device, a first reference signal to the another network device after adjusting the antenna array;
receiving, by the network device, a negative acknowledgement from the another network device when the another network device determines a measurement of the first reference signal is not greater than a threshold;
adjusting, by the network device, the antenna array of the network device by the second AoD of the second beam path information and the orientation of the network device;
transmitting, by the network device, a second reference signal to the another network device after adjusting the antenna array;
receiving, by the network device, a positive acknowledgement from the another network device when the another network device determines a measurement of the second reference signal is greater than the threshold;
determining, by the network device, the second AoD as the beam angle according to the positive acknowledgement.

18. The method of claim 17, further comprising:
transmitting, by the network device, the first AoA of the first beam path information and the second AoA of the second beam path information to the another network device so that the another work device adjusts an antenna array of the another network device by the first AoA of the first beam path information and the same orientation and by the second AoA of the second beam path information and the same orientation.

19. A method, comprising:
receiving, by a network device, at least one beam information from the another network device, wherein the at least one beam information corresponds to a first location of the another network device and a second location of the network device;
determining, by the network device, a beam angle for communicating with the another network device according to the at least one beam path information.

20. The method of claim 19, wherein the at least one beam path information includes a first beam path information having a first angle of arrival (AoA), and the step of determining the beam angle for communicating with the another network device according to the at least one beam path information further comprises:
adjusting an antenna array of the network device by the first AoA of the first beam path information and an orientation of the network device;
receiving a reference signal from the another network device after adjusting the antenna array;
determining the first AoA as the beam angle when a measurement of the reference signal is greater than a threshold;
transmitting a positive acknowledgement to the another network device.
